(19) United States
(12) Patent Application Publication
(10) Pub. No.: US 2025/0252331 A1
(43) Pub. Date: Aug. 7, 2025

(54) System for Topological Quantum Operation and Method Thereof

(71) Applicant: Nippon Telegraph and Telephone Corporation, Tokyo (JP)

(72) Inventors: Masayuki Hashisaka, Musashino-shi, Tokyo (JP); Victor Manuel Bastidas Valencia, Musashino-shi, Tokyo (JP)

(21) Appl. No.: 18/856,790

(22) PCT Filed: Apr. 18, 2022
(86) PCT No.: PCT/JP2022/018076

§ 371 Date: Oct. 14, 2024

(51) Int. Cl. G06N 10/20

(52) U.S. Cl. CPC G06N 10/20

(57) ABSTRACT

A topological quantum operation system according to the present disclosure includes: a waveguide in which a quantum bit is guided; an anyon generation unit that generates a quantum bit; a quantum gate operation unit that executes a braiding operation on at least a part of non-abelian anyons constituting the quantum bit; and a measurement unit that measures the quantum bit on which the braiding operation is performed, in which the quantum gate operation unit further includes: a plurality of waveguides having different branched lengths; and a switch that guides the non-abelian anyons included in the quantum bit to each of the plurality of waveguides having different branched lengths, and executes the quantum gate operation by generating a delay amount in at least the part of the non-abelian anyons.

### TECHNICAL FIELD

The present disclosure relates to a topological quantum operation system and a topological quantum operation method, and more specifically, to a quantum gate operation method in a topological quantum operation and a system thereof.

### BACKGROUND ART

A topological quantum computer is one type of a gate-type quantum computer, and is expected to have a low error occurrence rate due to decoherence in principle, and therefore is being actively researched regarding an effective method for realizing a gate-type quantum computer. In a topological quantum computer, particles (for the purpose of academic accuracy, called a quasiparticle) called non-abelian anyons expressed in a low-dimensional substance are used. The exchange of the positions of two non-abelian anyons leads to different quantum states being achieved, and this change is expressed as a unitary transformation to the wave function of the system. Such position exchange is regarded as an operation of entangling a “quantum string”, and is called a braiding operation (alternatively, braiding).

In the topological quantum computer, a plurality of non-abelian anyons are treated as a quantum bit as one set, and information such as “0” and “1” is encoded in a state where the non-abelian anyons (quantum strings) constituting the quantum bit are intertwined. Performing a braiding operation within individual topological quantum bits or between quantum bits to achieve a desired quantum state corresponds to a quantum gate operation in a topological quantum computer (see, for example, Non Patent Literature 1). It is expected that by performing the braiding operation in a state in which the non-abelian anyons are spatially separated from each other, it will be possible to suppress occurrence of errors due to the influence of the local external environment with respect to each of the non-abelian anyons and to execute a robust quantum operation.

As a braiding operation on a non-abelian anyon, for example, a method has been proposed in which two non-abelian anyons are captured at sets of spatial coordinates separated from each other in a two-dimensional system, and these coordinates are changed to circle the other non-abelian anyon around one non-abelian anyon (for example, Non Patent Literature 2). However, in this method, in the two-dimensional system, the non-abelian anyon needs to be moved in a desired trajectory, and in order to enable both one unitary transformation and its inverse transformation, the direction of the circling (clockwise or counterclockwise) needs to be able to be in both directions rather than in one direction, and an advanced control system therefor is required. As a result, since a long time is required for one braiding operation or a dedicated control wiring is required for each topological quantum bit, it is not suitable for speeding up the quantum operation (increasing the number of clocks) or increasing the scale (multi-quantized bit, multi-quantized gate).

With regard to realizing a useful topological quantum computer capable of solving a complicated problem, such a topological quantum operation method according to the prior art has a problem that quantum operation is slow and scalability is low. Therefore, there is a demand for a scalable architecture capable of realizing a braiding operation (quantum gate operation) at a high speed and easily increasing the number of quantum bits and the number of quantum gates.

### CITATION LIST

### Non Patent Literature

Non Patent Literature 1: C. Nayak, S. H. Simon, A. Stern, M. Freedman, S. Das Sarma, “Non-Abelian anyons and topological quantum computation,” Rev. Mod. Phys. 80, 1083 (2008).
Non Patent Literature 2: M. Freedman, C. Nayak, K. Walker, “Towards universal topological quantum computation in the v= 5/2 fractional quantum Hall state,” Phys. Rev. B 73, 245307 (2006).
Non Patent Literature 3: H. Bartolomei, M. Kumar, R. Bisognin, A. Marguerite, J.-M. Berroir, E. Bocquillon, B. Placais, A. Cavanna, Q. Dong, U. Gennser, Y. Jin, G. Feve, “Fractional statistics in anyon collisions,” Science 368, 173 (2020).
Non Patent Literature 4: J. Nakamura, S. Liang, G. C. Gardner, M. J. Manfra, “Direct observation of anyonic braiding statistics,” Nature Physics 16, 931 (2020).

### SUMMARY OF INVENTION

The present disclosure has been made in view of the above problems, and an object of the present disclosure is to provide a quantum operation system and a quantum operation method capable of executing a braiding operation at a high speed on a quantum bit configured of a non-abelian anyon propagating on a one-dimensional waveguide and executing such a braiding operation in a scalable manner a plurality of times.

In order to solve the problem as described above, the present disclosure provides a topological quantum operation system including: a waveguide in which a quantum bit is guided; an anyon generation unit that generates a quantum bit; a quantum gate operation unit that is connected to an output of the anyon generation unit and executes a braiding operation on at least a part of non-abelian anyons constituting the quantum bit; and a measurement unit that is connected to an output of the quantum gate operation unit and measures the quantum bit on which the braiding operation is performed, in which the quantum gate operation unit further includes: a plurality of waveguides having different branched lengths; and a switch that leads the non-abelian anyons included in the quantum bit to each of the plurality of waveguides having different branched lengths, and executes the quantum gate operation by generating a delay amount in at least a part of the non-abelian anyons.

Furthermore, in the present disclosure, there is provided a topological quantum operation method including: generating a quantum bit including a plurality of non-abelian anyons; guiding the generated quantum bits to a quantum gate operation unit to lead the non-abelian anyons to each of a plurality of branched waveguides; generating, in at least a part of the plurality of branched waveguides, a delay amount with respect to the non-abelian anyons to be guided; leading the plurality of non-abelian anyons, which have been guided to the plurality of branched waveguides, into one waveguide again to obtain a new quantum bit; and measuring the new quantum bit.

### BRIEF DESCRIPTION OF DRAWINGS

FIG. 1 is a diagram conceptually illustrating a configuration of a topological quantum operation system 10 according to the present disclosure, in which FIG. 1(a) illustrates a case of a clockwise braiding operation, and FIG. 1(b) illustrates a case of a counterclockwise braiding operation.

FIG. 2 is a flowchart illustrating a topological quantum operation method 20 according to the present disclosure.

FIG. 3 is a diagram conceptually illustrating a structure of a topological quantum operation system 30 having a variable beam splitter (hereinafter, referred to as BS) and a looped delay path and a flow of a quantum operation method according to a first embodiment of the present disclosure.

FIG. 4 is a diagram conceptually illustrating a disturbance of the interval between each non-abelian anyon caused by executing the topological quantum operation method according to the present disclosure.

FIG. 5 is a diagram illustrating a mode in which a part of a waveguide in which a non-abelian anyon is guided is branched and only a specific non-abelian anyon is leaded to a delay path in the topological quantum operation system according to the present disclosure.

FIG. 6 is a diagram illustrating a mode in which an input signal is injected on a specific non-abelian anyon to control the speed of the non-abelian anyon in the topological quantum operation system according to the present disclosure.

FIG. 7 is a diagram showing a configuration of an integrated topological quantum operation system 70 according to a second embodiment of the present disclosure.

### DESCRIPTION OF EMBODIMENTS

Hereinafter, various embodiments of the present disclosure will be described in detail with reference to the drawings. The same or similar reference signs denote the same or similar components, and redundant description may be omitted. The materials and numerical values are for illustrative purposes and are not intended to limit the scope of the disclosure. The following description is an example, and some configurations may be omitted, modified, or implemented together with additional configurations without departing from the gist of an embodiment of the present disclosure.

In the present specification, as a specific example of applying the topological quantum operation system and the topological quantum operation method according to the present disclosure, a non-abelian anyon of a fractional quantum Hall system is cited. In a fractional quantum Hall system with a Landau level occupancy of ⅓, it is known that a one-dimensional conduction state (edge state) occurs at a sample end, and an (abelian) anyon that moves in one direction using this edge state as a waveguide appears (see, for example, Non Patent Literatures 3 and 4). Similarly, in a fractional quantum Hall system with an occupancy of 5/2 or the like, it is considered that a non-abelian anyon that moves in one direction using an edge state appears (see, for example, Non Patent Literature 1). The topological quantum operation system and the topological quantum operation method according to the present disclosure are applicable to a non-abelian anyon in this fractional quantum Hall system.

In general, performing a quantum operation includes initializing a quantum state, performing a quantum gate operation, and measuring. A topological quantum operation system and method thereof according to the present disclosure includes, in a quantum gate operation (braiding operation) thereof, guiding each non-abelian anyon to a waveguide having a different length using a switch that operates at a high speed with respect to a non-abelian anyon array that is leaded on a one-dimensional waveguide.

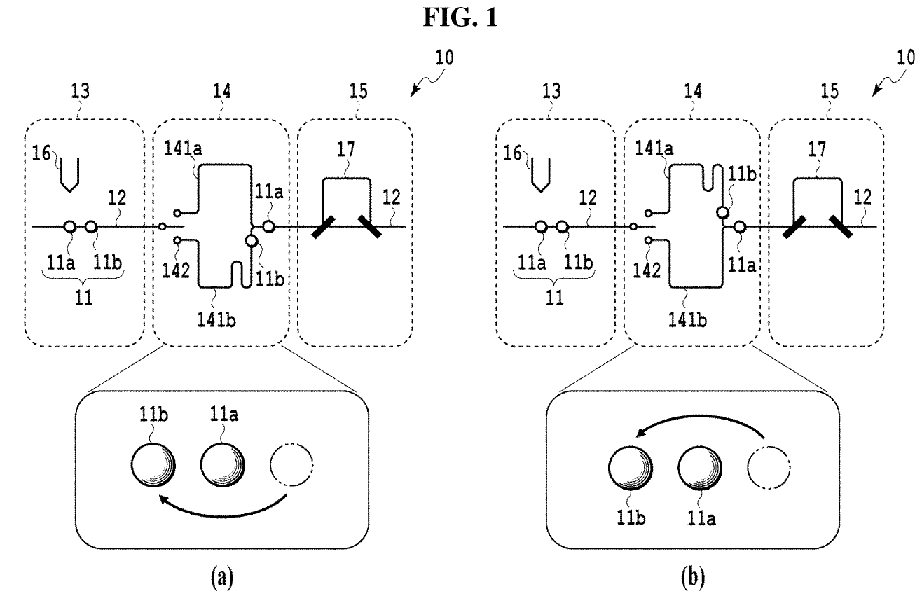

FIG. 1 is a diagram conceptually illustrating a configuration of a topological quantum operation system 10 according to the present disclosure, in which FIG. 1(a) illustrates a case of a clockwise braiding operation and FIG. 1(b) illustrates a case of a counterclockwise braiding operation. Here, for the sake of simplicity, the topological quantum operation system 10 according to the present disclosure is illustrated as generating, in the initialization of the quantum state, an anyon pair including two non-abelian anyons, and guiding the anyon pair on the waveguide in one direction (rightward in FIG. 1).

As illustrated in FIG. 1, the topological quantum operation system 10 according to the present disclosure includes a waveguide 12 in which a quantum bit (corresponding to an anyon pair 11 including the non-abelian anyons 11a and 11b in FIG. 1) is guided, an anyon generation unit 13 that generates a quantum bit (the anyon pair 11), a quantum gate operation unit 14 that is connected to an output of the anyon generation unit 13 and executes a braiding operation on the non-abelian anyons 11a and 11b, and a measurement unit 15 that is connected to an output of the quantum gate operation unit 14 and measures the anyon pair 11 subjected to the braiding operation. The anyon generation unit 13 further includes an anyon source 16 that generates an anyon pair 11 to be a quantum bit.

The quantum gate operation unit 14 further includes waveguides 141a and 141b having different branched lengths, and a switch 142 that leads the non-abelian anyons 11a and 11b included in the anyon pair 11 to each of the waveguides 141a and 141b. In addition, the measurement unit 15 further includes a measuring instrument 17 (for example, an interferometer) that measures a quantum bit guided by the waveguide 12 after the quantum gate operation is executed.

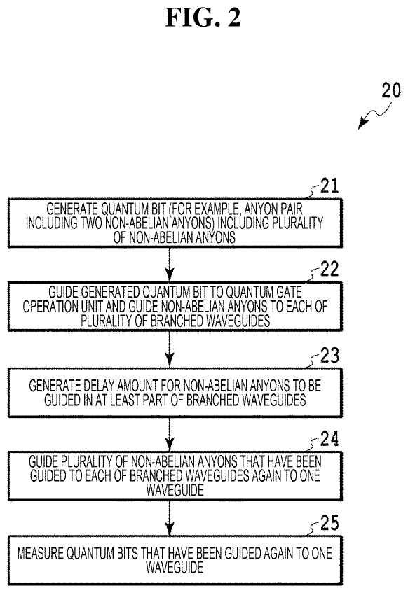

FIG. 2 is a flowchart illustrating a topological quantum operation method 20 according to the present disclosure. The topological quantum operation method 20 according to the present disclosure includes generating a quantum bit (for example, an anyon pair 11 including non-abelian anyons 11a and 11b) including a plurality of non-abelian anyons (step 21 in FIG. 2), leading the generated quantum bit to a quantum gate operation unit 14 and guiding the non-abelian anyons to each of a plurality of branched waveguides (for example, waveguides 141a and 141b) (step 22 in FIG. 2), generating a delay amount for the non-abelian anyons to be guided in at least a part of the branched waveguides (for example, one of 141a and 141b) (step 23 in FIG. 2), leading the plurality of non-abelian anyons that have been guided to each of the branched waveguides 141a and 141b again to one waveguide to become quantum bits (step 24 in FIG. 2), and measuring the quantum bits that have been leaded again to the one waveguide (step 25 in FIG. 2).

When the topological quantum operation method 20 is executed using the topological quantum operation system 10 as described above, the quantum gate operation unit 14 executes a braiding operation on the anyon pair 11. As illustrated in FIG. 1(a), when the non-abelian anyon 11a is leaded to the waveguide 141a, a clockwise braiding operation (a direction indicated by a curved arrow in FIG. 1(a)) is executed. On the other hand, as illustrated in FIG. 1(b), when the non-abelian anyon 11a is leaded to the waveguide 141b, the braiding operation in the counterclockwise direction (the direction indicated by the curved arrow in FIG. 1(b)) is executed. As described above, by using the topological quantum operation method and the system according to the present disclosure, a clockwise or counterclockwise braiding operation can be performed by selectively delaying a specific non-abelian anyon.

As described above, in the topological quantum operation method and the system according to the present disclosure, it is possible to perform the braiding operation simply by determining the path to guide the individual non-abelian anyons with the switch. For this reason, an advanced control system is unnecessary, and it is possible to easily increase the speed and scale of the quantum operation. In addition, when a propagation speed of the non-abelian anyon is v, and a length of the waveguide having no delay path or a short length is L₁, one operation can be completed at a time L₁/v. In other words, the braiding operation can be performed in a short time by adjusting the lengths of the plurality of waveguides with respect to the propagation speed of the non-abelian anyon.

In addition, in the topological quantum operation method and the system according to the present disclosure, even in a multi-quantum bit system including a plurality (three or more) of non-abelian anyons, by leading only the non-abelian anyon that performs the braiding operation to a route with delay paths, it is possible to perform the braiding operation similarly to the small-quantum bit system. That is, since it is not necessary to prepare a dedicated setup for each quantum bit, it can be said that an architecture having high scalability with respect to an increase in the number of quantum bits is provided.

As described above, the topological quantum operation method and the system according to the present disclosure can easily increase the speed and scale of the quantum operation as compared with the prior art, and have an architecture with high scalability with respect to an increase in the number of quantum bits. Therefore, there is an effect that a useful topological quantum computer that solves a complicated problem can be realized.

### First Embodiment

Hereinafter, a first embodiment of the present disclosure will be described in detail with reference to the drawings. The first embodiment of the present disclosure relates to a topological quantum operation method using a variable BS and a loop delay path and a system thereof.

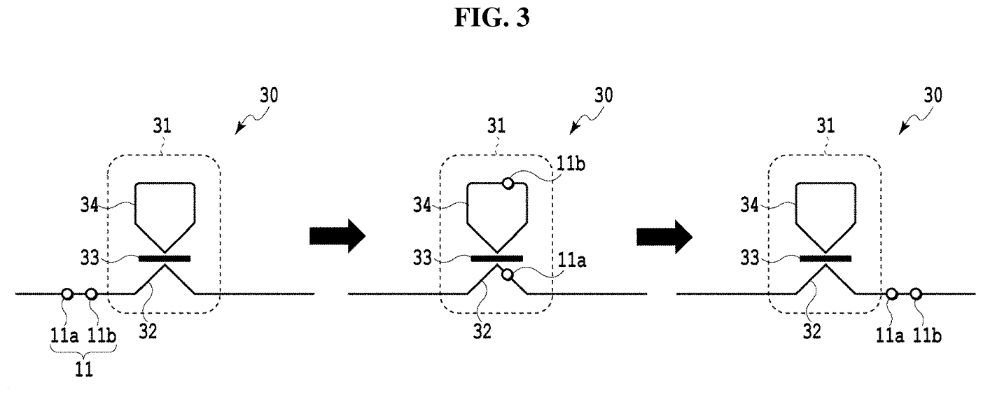

FIG. 3 is a diagram conceptually illustrating a structure of a topological quantum operation system 30 with a variable BS and a looped delay path and a flow of a quantum operation method according to the first embodiment of the present disclosure. Here, for the sake of simplicity, an anyon generation unit and a measurement unit are not illustrated, and only the quantum gate operation unit 31 is illustrated. As illustrated in FIG. 3, the quantum gate operation unit 31 of the topological quantum operation system 30 according to the present embodiment includes a waveguide 32 in which an anyon pair 11 including non-abelian anyons 11a and 11b is guided, a variable BS 33 configured to transmit only a specific non-abelian anyon (in FIG. 3, the non-abelian anyon 11b), and a loop delay path 34 that delays specific non-abelian anyons (in FIG. 3, the non-abelian anyon 11b). In the topological quantum operation system 30 in this embodiment, the loop delay path 34 corresponds to the different lengths of the branched waveguides 141a and 141b.

Now, in a case where a transmittance of the variable BS 33 is 1, it is assumed that the non-abelian anyon incident on the variable BS 33 transitions between the waveguide 32 and the loop delay path 34 with a probability of 100%, and in a case where the transmittance is 0, the non-abelian anyon incident on the variable BS 33 is reflected with a probability of 100%. Here, when the transmittance of the variable BS 33 is temporally changed to lead only the non-abelian anyon 11b to the loop delay path 34, a counterclockwise braiding operation is performed. In FIG. 3, the loop delay path 34 is installed on the upper side of the waveguide, but in a case where the loop delay path is installed on the lower side, a clockwise braiding operation is performed.

In FIG. 3, the quantum bits are illustrated as an anyon pair including two non-abelian anyons, but the braiding operation using such a topological quantum operation system 30 can also be extended to an anyon array including three or more non-abelian anyons. For example, order exchange occurs by increasing the number of times of circlings of one anyon in the loop delay path, and the braiding operation can be performed. The braiding operation can be similarly performed not only by adjusting the number of circlings but also by adjusting the length of the loop delay path 34 and the speed of the non-abelian anyon guided to the loop delay path 34. As described above, by selecting a non-abelian anyon to be leaded to the loop delay path 34 and adjusting the delay amount, various order exchanges (braiding operations) of a multi-quantum bit system can be performed even in a single braided operation device.

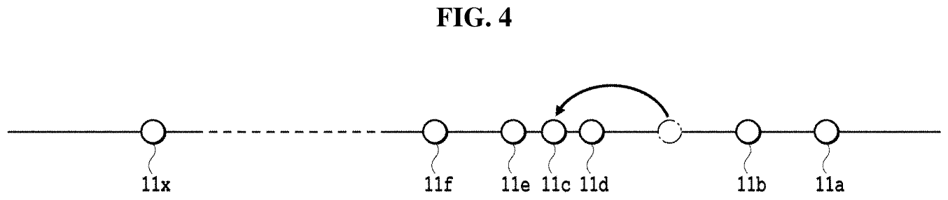

FIG. 4 is a diagram conceptually illustrating a disturbance of the interval between each non-abelian anyon caused by executing the topological quantum operation method according to the present disclosure. FIG. 4 illustrates a case where the braiding operation is performed on an anyon array having a plurality of non-abelian anyons 11a to 11x guided on the one-dimensional waveguide 12. As illustrated in FIG. 4, when the topological quantum operation method according to the present disclosure is executed on an anyon array in which a plurality of non-abelian anyons are arranged at equal intervals, a disturbance occurs in an interval between the respective anyons. This disturbance of the intervals can be corrected by providing an appropriate delay to each non-abelian anyon and back to an equally spaced anyon array. The topological quantum operation system 30 and the operation method using the same can also be applied to such delay control for correction.

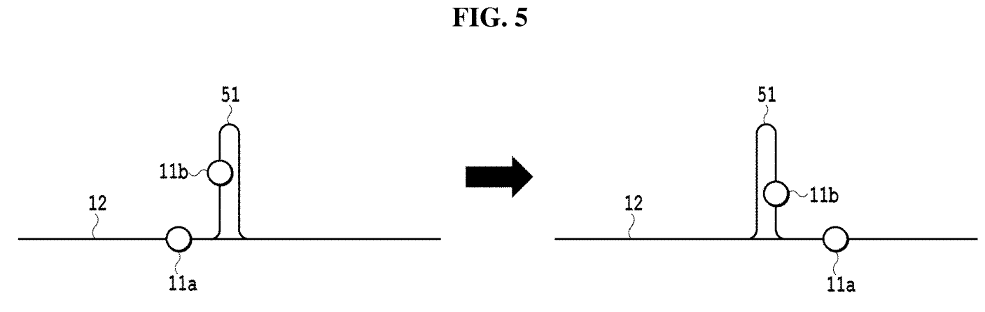

Note that, in the case of using such a topological quantum operation system 30, it has been described that different lengths of the waveguide are achieved by the loop delay path 34 in the above-described method. However, it is sufficient that the delay path has a structure in which a delay amount is generated only for a specific non-abelian anyon, and the shape of the delay path is not necessarily limited to a loop shape. For example, as illustrated in FIG. 5, a form may be adopted in which a part of the waveguide 12 in which the non-abelian anyons 11a and 11b are guided is branched, and only a specific non-abelian anyon (in FIG. 5, the non-abelian anyon 11b is used) is leaded to the delay path 51.

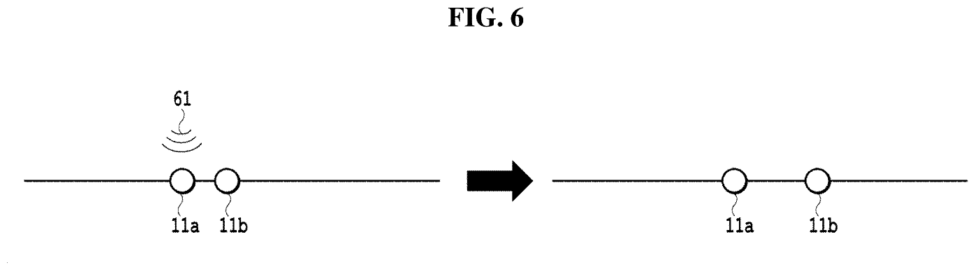

In addition, in the case of correcting the above-described disturbance of the interval between the non-abelian anyons, as illustrated in FIG. 6, the disturbance of the interval between the non-abelian anyons may be corrected by injecting an input signal 61 into a specific non-abelian anyon (in FIG. 6, the non-abelian anyon 11a is used) to control the speed of the non-abelian anyon (generate the delay amount).

### Second Embodiment

Hereinafter, a second embodiment of the present disclosure will be described in detail with reference to the drawings. The second embodiment of the present disclosure relates to a topological quantum operation system having a loop memory in which a plurality of quantum gate operation units are integrated.

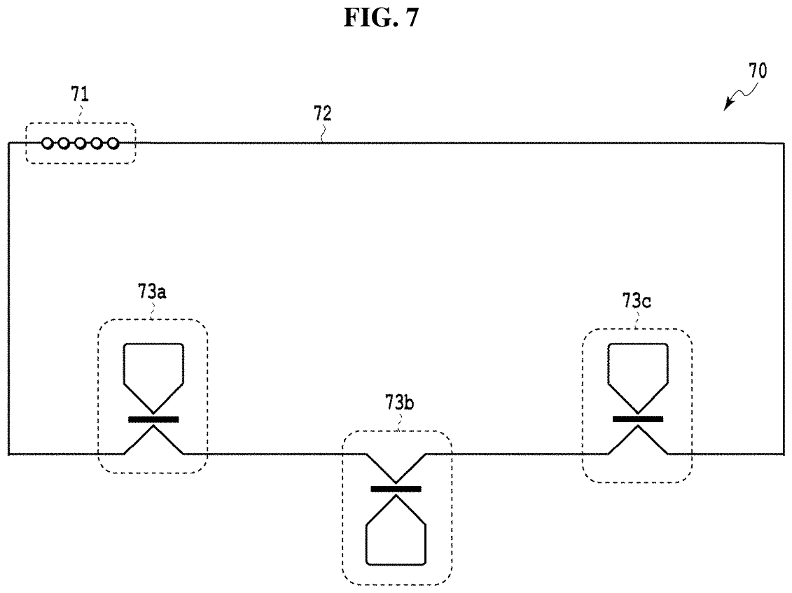

FIG. 7 is a diagram illustrating a configuration of an integrated topological quantum operation system 70 according to the second embodiment of the present disclosure. As illustrated in FIG. 7, the topological quantum operation system 70 according to the present embodiment includes an anyon array 71 to be a quantum bit, a one-dimensional waveguide 72 that forms a large loop (loop memory), and quantum gate operation units 73a to 73c that installed on the loop memory and execute a quantum gate operation on the anyon array 71. Here, the quantum gate operation unit 73a executes the quantum gate operation in the counterclockwise direction, the quantum gate operation unit 73b executes the quantum gate operation in the clockwise direction, and the quantum gate operation unit 73c executes the operation for correcting the interval between the anyons.

Note that, here, similarly to the quantum gate operation unit 31 illustrated in FIG. 3, the quantum gate operation units 73a to 73c are illustrated as having a variable BS and a loop delay path, but the form of generating the delay amount is not limited thereto, and the above-described various forms can be applied. In addition, in FIG. 7, it is described that the quantum gate operation unit 73a executes the quantum gate operation in the counterclockwise direction and the quantum gate operation unit 73b executes the quantum gate operation in the clockwise direction, but the order is not limited as long as the operation in the clockwise direction and the operation in the counterclockwise direction can be executed in series.

Furthermore, although the anyon generation unit and the measurement unit are not illustrated in FIG. 7, the anyon generation unit and the measurement unit may be installed in a loop shape, or may be separately installed outside the loop by branching a part of the loop.

In the topological quantum operation system 70 having such a configuration, the plurality of anyons constituting the anyon array 71 are circled on the waveguide 72 constituting the loop memory, and the order thereof can be maintained for a long time. Then, the quantum gate operation units 73a and 73b execute the braiding operation of the clockwise and counterclockwise braiding operations with respect to an arbitrary anyon constituting the anyon array 71. Thereafter, the disturbance of the interval between the anyons caused by the braiding operation is corrected by the quantum gate operation unit 73c. Such a series of braiding operations is executed each time of the circling, and the circling is repeated until all the target quantum gate operations are completed, and then the measurement is performed on the anyon array 71.

Using such a topological quantum operation system 70, any number of braiding operations can be performed using, for example, a set of clockwise and counterclockwise braiding operation devices and delay control devices for interval adjustment. That is, since it is not necessary to prepare a dedicated setup for each quantum gate, high scalability is obtained with respect to an increase in the number of quantum gates.

### INDUSTRIAL APPLICABILITY

As described above, the quantum operation method and the system according to the present disclosure have an architecture capable of realizing quantum gate operation at a higher speed than in the prior art and realizing high scalability. Therefore, application to a useful topological quantum computer capable of solving a complex problem is expected.

1. A topological quantum operation system comprising:
an anyon generation unit that generates a quantum bit;
a quantum gate operation unit that is connected to an output of the anyon generation unit, executes a braiding operation on at least a part of non-abelian anyons constituting the quantum bit, wherein:
the quantum gate operation unit includes a plurality of waveguides having different branched lengths, and a switch that leads the non-abelian anyon included in the quantum bit to each of the plurality of waveguides having different branched lengths; and
the quantum gate operation unit executes the braiding operation by generating a delay amount in at least the part of the non-abelian anyons; and
a measurement unit that is connected to an output of the quantum gate operation unit and measures the quantum bits subjected to the braiding operation.

2. The topological quantum operation system according to claim 1, wherein the quantum gate operation unit further comprises:
a variable beam splitter that transmits only a specific non-abelian anyon; and
a delay path for generating the delay amount.

3. The topological quantum operation system according to claim 1, wherein the quantum gate operation unit further comprises a mechanism that corrects a disturbance of an interval of the non-abelian anyons caused by the braiding operation.

4. The topological quantum operation system according to claim 1, wherein:
a waveguide that the quantum bit is guided forms a loop memory; and
the quantum gate operation unit further comprises:
a first operation unit that performs the braiding operation in a clockwise direction;
a second operation unit that performs the braiding operation in a counterclockwise direction; and
a third operation unit wherein the third operation unit corrects a disturbance of an interval of the non-abelian anyons generated by the braiding operation.

5. A topological quantum operation method comprising:
generating a quantum bit including a plurality of non-abelian anyons;
guiding the generated quantum bits to a quantum gate operation unit to lead the non-abelian anyons to each of a plurality of branched waveguides;
generating, in at least a part of the plurality of branched waveguides, a delay amount with respect to the non-abelian anyons to be guided;
leading the plurality of non-abelian anyons that have been guided to the plurality of branched waveguides into one waveguide again to obtain a new quantum bit; and
measuring the new quantum bit.

6. The topological quantum operation method according to claim 5, further comprising correcting a disturbance of an interval between the plurality of non-abelian anyons after generating the delay amount.

7. The topological quantum operation method according to claim 6, wherein:
generating the delay amount comprises:
a clockwise braiding operation; and
a counterclockwise braiding operation, and
the topological quantum operation method is repeatedly executed until all target quantum gate operations are completed.
